(19) United States
(12) Patent Application Publication
(10) Pub. No.: US 2019/0135480 A1
(43) Pub. Date: May 9, 2019

(54) FOOD SCOOP WITH SEALED BOTTOM

(71) Applicant: Huhtamaki, Inc., De Soto, KS (US)

(72) Inventors: Mike Crayne, Shawnee, KS (US); Ronald Robertson, Kansas City, MO (US)

(21) Appl. No.: 16/185,820

(22) Filed: Nov. 9, 2018

Related U.S. Application Data
(60) Provisional application No. 62/583,993, filed on Nov. 9, 2017.

(51) Int. Cl. B65D 5/18; B65D 5/42; B31B 50/62; B31B 50/26

(52) U.S. Cl. CPC B65D 5/18; B65D 5/4266; B31B 2110/10; B31B 50/26; B31B 50/622

(57) ABSTRACT

A food scoop for holding food items is provided. The food scoop can include a perimeter sidewall formed by front and rear wall panels, a bottom panel connected to the lower ends of the front and rear wall panels, a tuck panels folded upwardly from the bottom panel on opposite sides to form a sealed bottom of the food scoop. The tuck panels can be positioned between the front and rear wall panels along an overlapping region of the sidewall to secure and enclose the lower portion of the sidewall to form the sealed bottom. The food scoop can be formed from a unitary blank having fold lines formed thereon to define the bottom panel, front and rear wall panels, and tuck panels.

### CROSS-REFERENCE TO RELATED APPLICATIONS

This Application claims priority to U.S. Provisional Patent Application Ser. No. 62/583,993, filed Nov. 9, 2017, to Mike Crayne et al., entitled “Food Scoop with Sealed Bottom Having Tuck Panels,” currently pending, the entire disclosure of which is incorporated herein by reference.

### BACKGROUND OF THE INVENTION

Folded and bonded paperboard, corrugated cardboard and foam scoops and containers are often used in the fast food and quick serve restaurant industry.

It can be desirable for scoops, especially those used for holding food products, to include a generally sealed bottom so as to prevent food, and any salt, seasonings, breading and dressings placed thereon, from escaping through the bottom of the scoop. Because scoops are typically manufactured in the hundreds of thousands, incremental decreases in materials and glue and increased efficiency in handling and use can lead to significant cost savings.

Because these scoops are used in such large quantities, it is desirable that they can be produced, assembled and stored easily and efficiently in order to minimize cost and assembly. It is also desirable for these scoops to be easily stacked and nested together during shipment, storage and dispensing. However, disadvantageous designs and constructions can result in multiple scoops sticking together when a user intends to grab only one scoop from the stack. Any small variation in size or shape among the scoops, or disadvantageous placement or folding of parts can lead to the scoops not fully nesting and can also result in interferences that lead to difficulty in removing just one scoop from the stack.

Thus, a need exists for a scoop having a generally sealed bottom that can be produced with minimal amounts of material and glue in order to promote cost savings. A need also exists for a scoop that can be produced in high volumes while maintaining tolerances of manufacture that result in the scoops being of precisely the same size and shape.

### SUMMARY OF THE INVENTION

The present invention is directed to a container or scoop for holding various items, including food items and the like. The scoop can include a generally cylindrical or frustoconical peripheral sidewall with a slightly rectangular bottom portion and a generally cylindrical top portion. The sidewall can be formed from a front wall panel and a rear wall panel, each having side edge portions that are adhesively bonded in a generally overlapping relationship to form opposed side seams. The front and rear wall panels may be foldably connected to and extend from a bottom panel that forms the base of the scoop. To form the scoop, the front and rear wall panels may be folded up about the bottom panel and the side edge portions may be wrapped around the adjacent lateral side edges of the bottom panel and secured together to form the overlapping seams and enclosed sidewall.

According to one embodiment of the present invention, the scoop may include a pair of tuck panels or side sealing flaps extending from the lateral side edges of the bottom panel. The side sealing flaps may be folded upward and positioned between the front and rear wall panels at the sidewall side seams in order to fully enclose or seal the base of the scoop. An adhesive or other bonding material may be applied to the edge portions of each wall panel along the overlapping seam to secure panels together with the side sealing flap therebetween to form the sidewall and sealed lower portion of the scoop. According to one embodiment of the present invention, the side sealing flap is bonded to only one of the front and rear panels and can remain secured in place by the bonding forces of the overlapping seam.

According to one embodiment, the side sealing flaps of the scoop may have a generally rectangular shape and the terminal end can extend horizontally across the entire length of the bottom portion of the scoop. According to another embodiment, the side sealing flaps may have a trapezoidal shape where the terminal end has a length less than the base end, which can facilitate concealing the terminal edge fully between the edge portions of the front and rear wall panels.

According to one embodiment, each wall panel includes side edge portions that extend beyond the bottom panel, where the length of the rear panel edge portion is approximately equal to the length of bottom panel sides and greater than the length of the front panel edge portion. This configuration can prevent the sealing flap from being exposed along the interior portion of the peripheral sidewall, which can otherwise disadvantageously effect the stacking capabilities of the scoop. According to another embodiment the length of the rear panel edge portion is less than that of the length of the bottom panel sides but approximately equal to an effective length of a terminal edge of the sealing flaps (when the sealing flaps have a trapezoidal shape), which can prevent the terminal edge from being exposed along the interior portion of the scoop.

The present invention also involves the provision of a blank adapted for constructing the scoop. The blank may comprise the front and rear wall panels and the adjoining bottom panel on opposing longitudinal sides of the bottom panel and side sealing panels adjoining the bottom panel of opposing lateral sides of the bottom panel. The blank may be constructed as a single piece of material and formed into shape around a forming head to produce the scoop.

Other and further objects of the invention, together with the features of novelty appurtenant thereto, will appear in the course of the following description.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a side perspective view of a scoop in accordance with one embodiment of the present invention;

FIG. 2 is a right side view of the scoop of FIG. 1;

FIG. 3 is a front side view of the scoop of FIG. 1;

FIG. 4 is a plan view of a blank of material adapted to form the scoop of FIG. 1 in accordance with one embodiment of the present invention;

FIG. 5 is a side perspective view of a scoop in accordance with another embodiment of the present invention;

FIG. 6 is a front perspective view of the scoop of FIG. 5;

FIG. 7 is a plan view of a blank of material adapted to form the scoop of FIG. 5 in accordance with one embodiment of the present invention;

FIG. 8A is a partial plan view of a blank of material adapted to form a scoop according to one embodiment of the present invention;

FIG. 8B is a partial plan view of a blank of material adapted to form a scoop according to another embodiment of the present invention;

FIG. 9 is a top perspective view of the scoop of FIG. 1 illustrating an interior of the scoop in accordance with one embodiment of the present invention; and

FIG. 10 is a top perspective view of the scoop of FIG. 5 illustrating an interior of the scoop in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing figures are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The present invention is directed toward a container or scoop 10 as illustrated in the several figures and configured for holding various items, including but not limited to food items. Scoop 10 may be constructed from a material blank 100 (as described in greater detail below) that may be folded and formed into scoop 10. Scoop 10 may be constructed from any suitable type of material, including but not limited to a paperboard material.

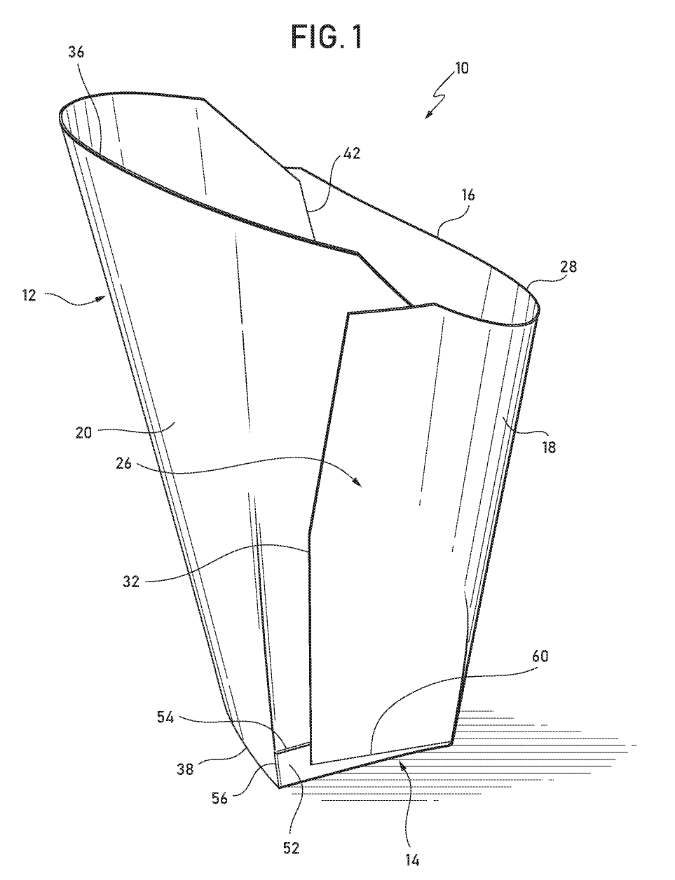

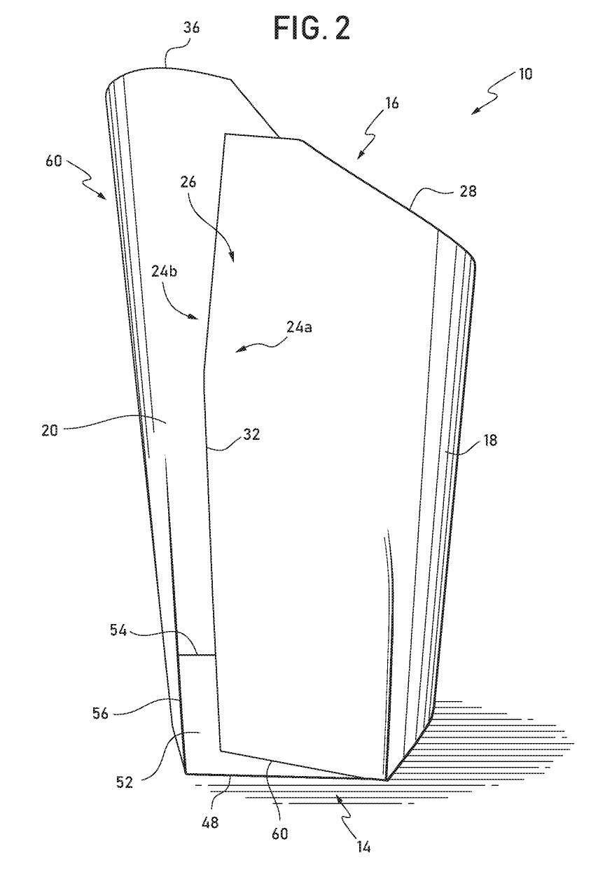

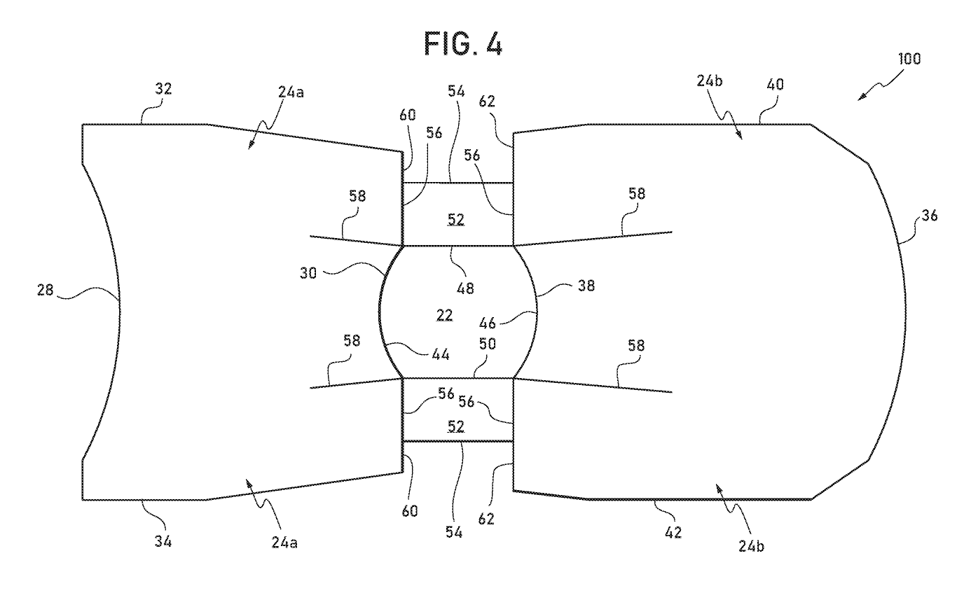

As best shown in FIGS. 1-3, container or scoop 10 of the present invention may include an upright peripheral sidewall 12, which may be of a generally cylindrical configuration and, in one embodiment, takes on a generally frustoconical shape increasing in cross section from a lower end portion 14 to an upper end portion 16. The lower end portion 14 of the scoop 10 may have a substantially rectangular, polygonal, reuleaux polygonal, oval, circular or similar cross section and the upper end portion 16 of the scoop 10 may have a generally oval or circular cross section. As shown in FIG. 1, peripheral sidewall 12 may be formed from a front wall panel 18 and a rear wall panel 20, each extending from a bottom panel 22 of scoop 10. As shown in FIG. 2 (and in the blank 100 of FIG. 4), front wall panel 18 and rear wall panel 20 may each have side edge portions 24a and 24b, respectively, that can be arranged in a generally overlapping fashion to form side seams 26. Side edge portions 24a and 24b may be secured together using any suitable method, including using adhesive or applying heat sealing or the like in order to from the peripheral sidewall 12 with overlapping side seams 26.

As shown in FIGS. 1-4, the front wall panel 18 may include a top edge 28, a bottom edge 30 and opposing lateral side edges 32 and 34. As further shown in FIGS. 1-4, top edge 28 of front wall panel 18 may have a curved and concave shape according to one embodiment; however, in alternative embodiments of scoop 10, top edge 28 may have any suitable shape, including, curved, linear or an alternative. The rear wall panel 20 may similarly include a top edge 36, a bottom edge 38 and opposing lateral side edges 40 and 42. As also shown in FIG. 1-4, top edge 36 of the rear wall panel 20 may have a curved and convex shape according to one embodiment; however, similar to top edge 28, in alternative embodiments, top edge 36 may be of any suitable shape, including curved, linear or an alternative.

As best shown in FIGS. 1 and 4, bottom panel 22 may be foldably joined to front panel 18 and rear panel 20 along bottom edges 30 and 38, respectively. As best shown in FIG. 4, bottom panel 22 may include a front longitudinal edge 44, a rear longitudinal edge 46 and lateral side edges 48 and 50. Bottom edges 30 and 38 of front and rear panels 18 and 20, respectively, may be foldably joined (i.e., connected by a fold line) to bottom panel 22 along front and rear longitudinal edges 44 and 46, respectively. As shown in FIG. 4, the front and rear longitudinal edges 44 and 46 of bottom panel 42 may be generally coextensive with bottom edges 30 and 38 of wall panels 18 and 20 along a portion of the bottom edges 30 and 38 (which may also extend beyond longitudinal edges 44 and 46 as described below). The bottom panel 42 can serve to close off the lower end portion 14 of the scoop 10, as illustrated in FIGS. 1-3. According to one embodiment, the front wall panel 18, rear wall panel 20 and bottom panel 42 may be formed from a single piece of material or blank 100 as shown in FIG. 4.

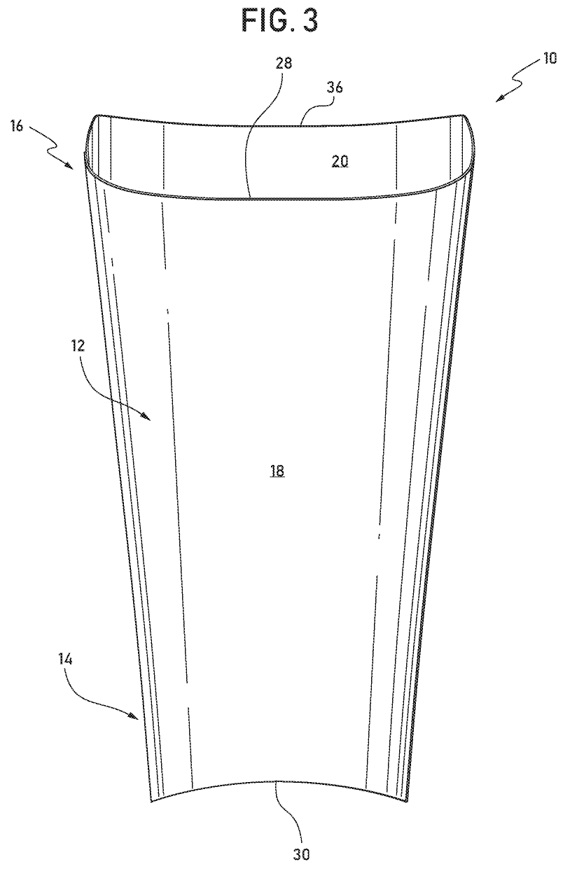

As best shown in FIG. 4, the front and rear longitudinal edges 44 and 46 of bottom panel 22 may have a curved shape that provide a convex shape extending outward into the respective front or rear wall panel 18 or 20. As best shown in FIG. 3, the convex shape of longitudinal edges 44 and 46 can provide lower end portion 14 of scoop 10 with an upward arcuate shape extending between lateral edges 48 and 50 of bottom panel 22 when blank 100 is formed into scoop 10.

As best shown in FIG. 4, bottom panel 22 may include a pair of opposed side sealing flaps or tuck panels 52 extending from lateral side edges 48 and 50. Tuck panels 52 may be connected to bottom panel 22 along lateral side edges 48 and 50 by a fold line and include a terminal free edge 54 opposite its base edge located at the respective lateral side edge 48 or 50. Tuck panels 52 may be configured to be folded upward and positioned between the overlapping wall panel edge portions 24a and 24b of sidewall 12 and side seams 26 (as described in greater detail below) in order to seal or generally enclose lower end portion 14 of scoop 10 when blank 100 is formed into scoop 10.

According to one embodiment as best shown in FIGS. 1-4, tuck panels 52 may be configured into a generally rectangular shape. In such an embodiment, each tuck panel 52 may include longitudinal side edges 56 extending between its respective lateral side edge 48 or 50 (connecting tuck panel 52 to bottom panel 22) and its terminal free edge 54 on each longitudinal end of tuck panel 52 in a generally parallel relationship to form a generally rectangular perimeter of each tuck panel 52. In addition, in this embodiment, longitudinal side edges 56 of each tuck panel 52 can extend adjacent to generally along the lower bottom edges 30 and 38 of front and rear wall panels 18 and 20 as best illustrated in FIG. 4.

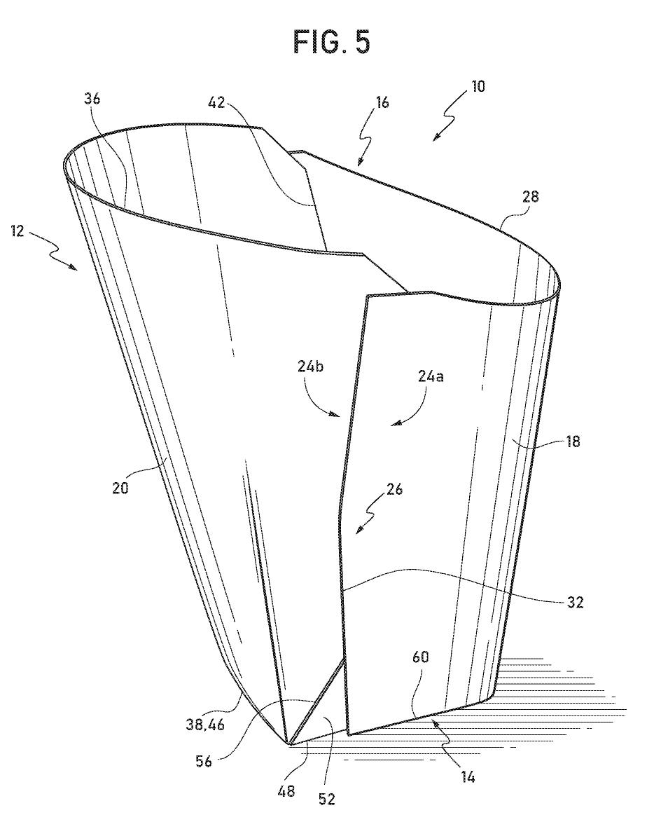

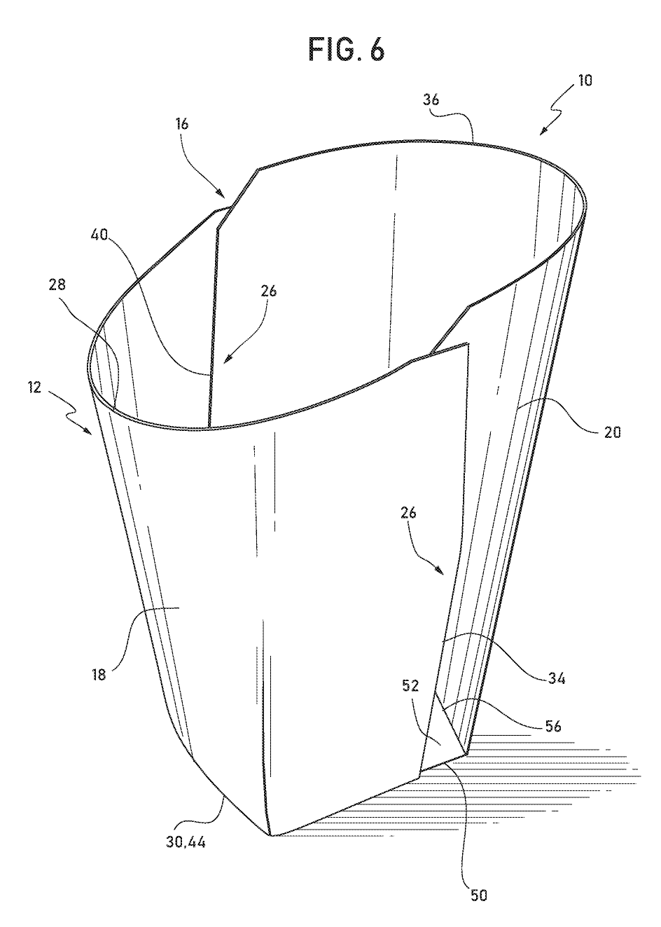

According to another embodiment of the present invention as best shown in FIGS. 5-7, tuck panels 52 may configured into a generally trapezoidal shape. In such an embodiment, longitudinal side edges 56 of each tuck panel 52 may extend between its respective lateral edge 48 or 50 and its terminal edge 54 in an angled fashion such that the width of each tuck panel 52 gradually reduces from lateral edge 48 or 50 to terminal free edge 54. As a result of the inwardly angled longitudinal side edges 56 and the trapezoidal shape of tuck panels 52 in this configuration, the length of terminal free edge 54 is less than the length of lateral side edge 48 or 50. In further alternative embodiments (not shown) tuck panels 52 may have any other suitable or desirable shape, such as but not limited to, a triangular, circular, rounded or other shape.

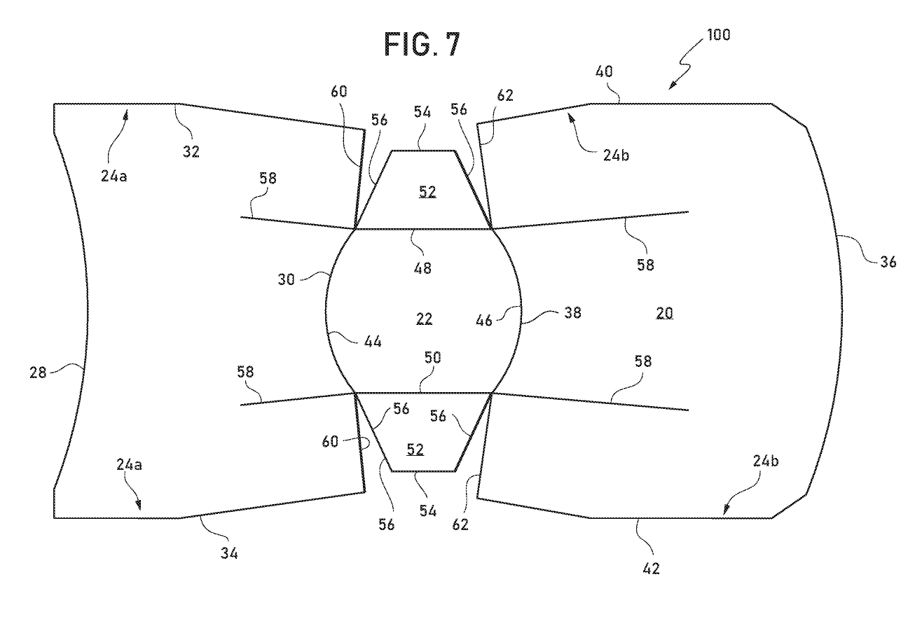

As best illustrated in FIGS. 4 and 7, in certain embodiments of the present invention front and rear wall panels 18 and 20 may optionally include one or more generally vertical forming lines 58 that can assist in the forming the overall shape of scoop 10 once formed from a blank 100. Forming lines 58 may be marked, etched, embossed, scored or otherwise included thereon and all or partially upward from bottom edge 30 or 38 toward top edge 28 or 36 of the respective wall panel 18 or 20. According to one embodiment, forming lines 58 may facilitate the forming of scoop 10 from blank 100 and/or provide a generally rectangular shape at lower end portion 14 of the formed scoop 10 by urging the partial folding and/or curving of front and rear wall panels 18 and 20 along forming lines 58 when front and rear wall panels 18 and 20 are wrapped around bottom panel 22.

As best shown in FIGS. 4 and 7, in certain embodiments of the present invention bottom edge 38 of rear wall panel 20 may include extension or end portions 62 located on each side of bottom panel 22. As shown, end portions 62 extend beyond bottom panel longitudinal edge 46 and form portions of bottom edge 38 (of rear wall panel 20) that are not connected to bottom panel 22. As also shown in FIGS. 4 and 7, bottom edge 30 of front wall panel 18 may include similar end portions 60 located on each side of the rear longitudinal edge 44 of bottom panel 22. Similar to end portions 62, end portions 60 may extend beyond bottom panel longitudinal edge 44 and form portions of bottom edge 30 (of front wall panel 18) that are not connected to bottom panel 22. Each of the end portions 60 and 62 corresponding to front and rear wall panels 18 and 20, respectively, can also be coextensive with and form the lower edge of side edge portions 24a and 24b for front and rear wall panels 18 and 20 according to certain embodiments as best shown in FIGS. 1 and 5. As further shown in FIGS. 4 and 7, end portions 60 and 62 may have a generally linear shape in certain embodiments of the present invention.

As best shown in both FIGS. 1-2 and FIGS. 5-6, scoop 10 can be formed and configured with tuck panels 52 positioned between front and rear wall panels 18 and 20 in an overlapping relationship along side seams 26 of peripheral sidewall 12. As shown, tuck panels 52 can be positioned on the outside of (e.g., along the exterior side of) the side edge portion 24b of rear wall panel 20 and on the inside of (e.g., along the interior side of) the side edge portions 24a of front wall panel 18 when scoop 10 is formed.

As further shown in FIGS. 1-2 and 5-6, when blank 100 is formed into scoop 10, each side edge portion 24b of rear wall panel 20 may be wrapped around the lateral sides of bottom panel 22 so that end portions 62 of the rear wall panel 20 may be wrapped around and overlie the corresponding lateral side edges 48 and 50 of bottom panel 22. Tuck panels 52 may then be folded upward against the outer portion (e.g., exterior side) of end portions 62 and rear wall 20. The side edge portions 24a of the front wall panel 18 may then be wrapped around the lateral sides of bottom panel 22 so that end portions 60 of front wall panel 18 overlie the corresponding side edges 48 and 50 and are positioned against tuck panels 52 and end portions 60. In this configuration, side edge portions 24b and end portions 62 of rear wall panel 20 are located on the interior side of sidewall 12 and side edge portions 24a and end portions 60 of front wall panel 18 are located on the exterior side of sidewall 12. The tuck panels 52 may be positioned between the side edge portions 24a and 24b (and end portions 60 and 62) of the front and rear wall panels 18 and 20, respectively, to seal the lower end portion 14 of the scoop 10.

In an alternative configuration, scoop 10 can be formed such side edge portions 24a and end portions 60 of front wall panel 18 are located on the interior side of sidewall 12 and side edge portions 24b and end portions 62 of rear wall panel 20 are located on the exterior side of sidewall 12. Nonetheless, in this configuration, the tuck panels 52 are still folded upward and are located (at least partially) between the side edge portions 24 of the front wall panel 18 and the side edge portions 24 of the rear wall panel 20.

In either configuration (and as described in greater detail below), because each tuck panel 52 is sandwiched between a side edge portion 24a of front wall panel 18 and a side edge portion 24b of rear wall panel 20, only a small amount of glue, adhesive or bonding agent (if any all) is necessary for securing the tuck panels 52 in place. In one embodiment, the tuck panels 52 are only adhesively secured to the side edge portions 24a of front wall panel 18. In another embodiment, the tuck panels 52 are only adhesively secured to the side edge portions 24b of rear wall panel 20. In a further embodiment, the tuck panels 52 are not bonded or adhesively secured to either the front wall panel 18 or the rear wall panel 20 because the forces from the secured overlapping seams 26 above the tuck panels 52 may be sufficient to maintain the sealed and upright orientation of the tuck panels 52 between the respective side edge portions 24a and 24b of the front and rear wall panels 18 and 20, respectively.

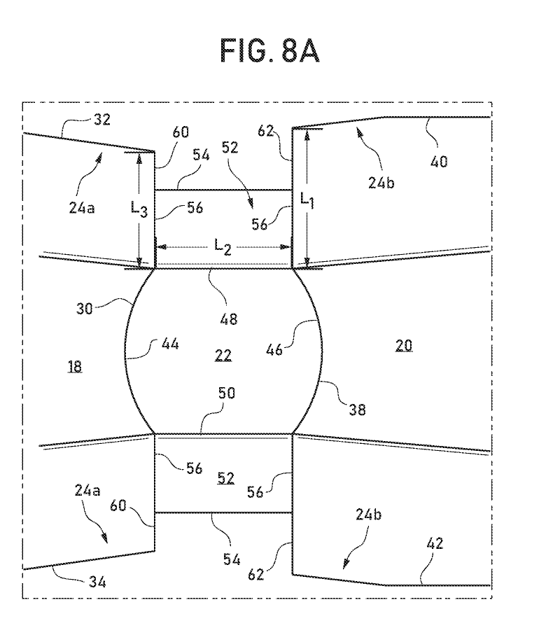

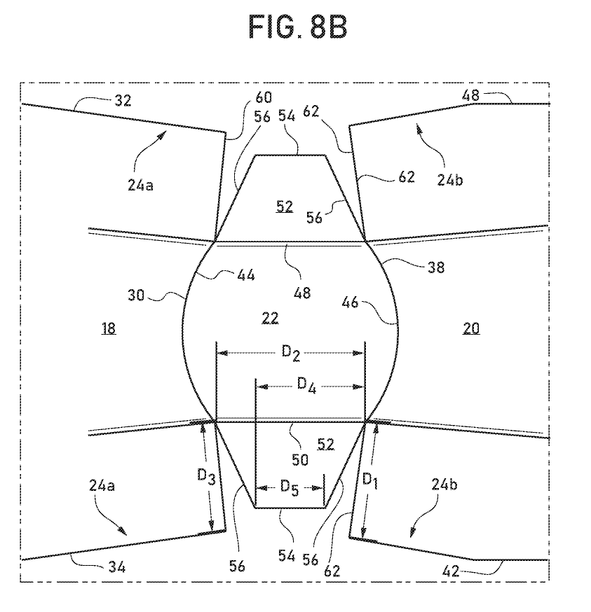

Turning now to FIG. 8A which provides a more detailed partial view of FIG. 4, the dimensional relationships among bottom panel edges 44-50, tuck panels 52, and end portions 60 and 62 corresponding to side edge portions 24a and 24b of front and rear wall panels 18 and 20 are shown in accordance with one embodiment of the present invention. According to this embodiment, end portions 62 (of the rear wall panel 20 and side edge portions 24b) may have a length L₁ that is approximately equal to the width or length L₂ of the corresponding lateral side edge 48 or 50 (of the bottom panel 22) or based edge of tuck panels 52. In this configuration, when scoop 10 is formed from blank 100 and edge portions 24b of rear wall panel 20 are wrapped around bottom panel 22, the end portions 62 of rear wall panel bottom edge 38 may substantially overlie and be generally coextensive with corresponding lateral side edge 48 or 50. The generally equal dimensions of L₁ and L₂ allow for the end portions 62 (and the wall panel edge portions 24b extending upward therefrom) to extend across substantially the entire lateral width of the bottom panel 22 as defined by lateral side edges 48 or 50, as illustrated in FIG. 9.

In addition, according to such an embodiment as illustrated in FIG. 8A, end portions 60 for front wall panel 18 (and corresponding to side edges portions 24a) may have a length L₃ that may be less than the lengths L₁ of rear wall end portions 62 (corresponding to side edge portions 24b) and L₂ of bottom panel lateral edges 48 and 50 (corresponding to the base edge of tuck panels 52). In this configuration, when edge portions 24a of front wall panel 18 are wrapped around bottom panel 22, the end portions 60 of front wall panel 18 (and edge portions 24 extending upward therefrom) do not extend across the entire width of bottom panel 22 as shown in FIG. 1; however, the lower end portion 14 of the scoop 10 remains sealed by rear wall panel 20 on the interior portion of the scoop sidewall 12 and the upwardly folded tuck panels 52

This configuration can allow for a superior sealing of lower end portion 14 of the scoop 10 while minimizing the total amount of material required for blank 100. When end portions 62 have a length L₁ approximately equal the length L₂ of bottom panel side edges 48 and 50, end portions 62 (and the rear wall panel edge portions 24b extending upward therefrom) substantially cover the terminal edges 54 of the tuck panels 52 on the interior side of sidewall 12 as shown in FIG. 9. This can prevent or reduce the likelihood that the tuck panels 52 can impede or become bent when attempting to nest multiple scoops 10 together since the terminal edges 54 of the tuck panels 52 are not exposed in the interior of the scoop. In addition, because end portions 60 of front wall panel 18 (corresponding to side edge portions 24a) are positioned on the outside portion of the peripheral sidewall 12 of the scoop 10, they may have a length L₃ less than L₁ and L₂, which can reduce the total amount of material of blank 100 while not impacting the performance or nesting capabilities of scoop 10. It will also be appreciated that, in other embodiments, the length L₁ of end portions 62 of the rear wall panel 20 may greater than the length L₂ of the tuck panels 52 such that the end portions 62 extend beyond and shield the terminal edges 54 of tuck panels 52 along the interior of the scoop sidewall 12.

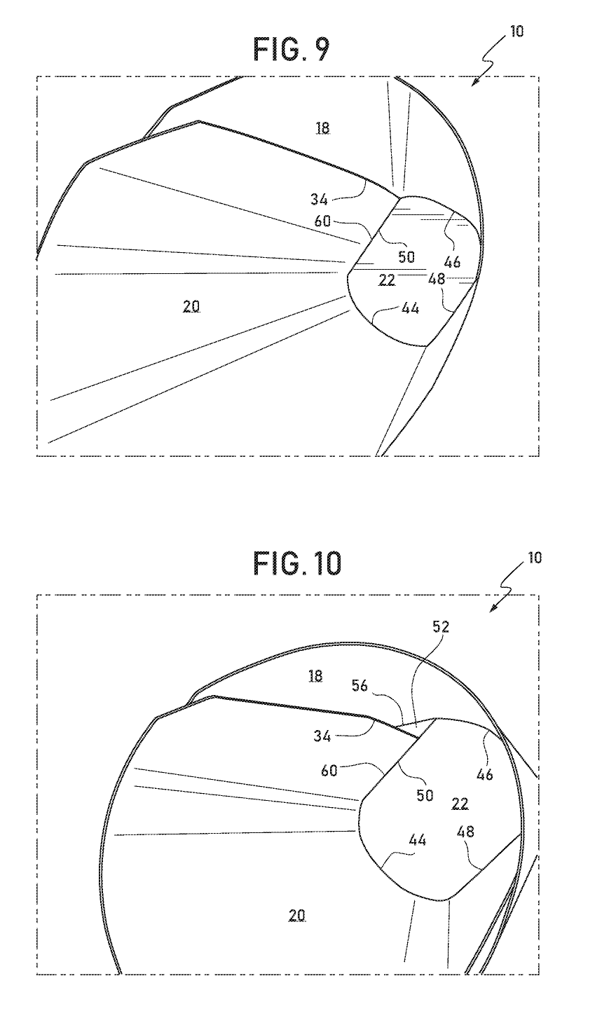

FIG. 8B similarly provides a more detailed partial view of FIG. 7 and illustrates the dimensional relationships among bottom panel edges 44-50, tuck panels 52, and end portions 60 and 62 corresponding to side edge portions 24a and 24b of front and rear wall panels 18 and 20 in accordance with another embodiment of the present invention. According to this embodiment, tuck panels 52 extending from bottom panel 22 may have slightly inwardly angled or tapered side edges 56 providing a generally trapezoidal shape where terminal edge 54 has a length less than the folding edge 48 or 50 connecting the tuck panel 52 to bottom panel 22. In this embodiment, end portion 62 (corresponding side edge portions 24b) of rear wall panel 20 may have a length D₁ less than a length D₂ of lateral side edge 48 or 50 of bottom panel 22 from which tuck panel 22 extends. As further shown in FIG. 8B, the length D₁ of end portions 62 may instead be configured to be approximately equal to (or slightly greater than) an effective length of terminal edge 54, length D₄, which is defined by the distance between the corner of folded edge 48 or 50 of tuck panel 52 (and bottom panel 22) and the opposite corner of the terminal edge 54 of the tuck panel 52. This effective length D₄ can also be described as length D₅ plus half the difference between length D₂ and length D₅, where length D₅ is the actual length of terminal free edge 54 of tuck panels 52 (i.e., D₅+[[D₂−D₅]/2]). As illustrated in FIG. 8B, this length D₄ is less than the length D₂ of lateral side edge 48 or 50 of bottom panel 22 due to the inwardly angled sides 56 of tuck panels 52. In this embodiment, the length D₁ of rear wall panel end portions 62 allow end portions 62 (and rear wall panel edge portions 24b extending upward therefrom) to extend across bottom panel lateral side edges 48 and 50 a sufficient distance to cover the terminal edges 54 of tuck panels 52 along the interior of the scoop sidewall 12, as best illustrated in FIG. 10. Additionally, as shown in FIG. 8B, end portions 60 (corresponding to side edge portions 24a) of front wall panel 18 may have a length D₃ approximately equal to or less than length D₄ due to the fact that front wall panel 18 is provided along exterior of scoop sidewall 12.

For merely exemplary purposes only, and not intended in any way to be limiting, according to one embodiment of the present invention, scoop 10 can be configured with approximately the following dimensions for lengths L₁-L₃ as illustrated in FIG. 8A: L₁ can have a length of 1.6250 inches, L₂ can have a length of 1.6250 inches, and L₃ can have a length of 1.3750 inches. In addition, according to another embodiment of the present invention, scoop 10 can be configured with approximately the following dimensions for lengths D₁-D₅ as illustrated in FIG. 8B: D₁ can have a length of 1.2500 inches, D₂ can have a length of 1.6250 inches, D₃ can have a length of 1.1875 inches, D₄ can have a length of 1.1875 inches, and D₅ can have a length of 0.7500 inches. The foregoing exemplary dimensions are provided merely to show the potential dimensional arrangements of scoop 10 depending on the particular embodiment, and it is also recognized that scoop 10 and the components thereof may have any number of other suitable dimensions depending on the particular embodiment of the present invention.

According to one embodiment of the present invention, scoop 10 is formed from material blank 100 (as shown in FIGS. 1 and 4) by folding front and rear wall panels 18 and 20 upward from bottom panel 22 about edges 30 and 38 (and corresponding longitudinal edges 44 and 46 of bottom panel 22) and wrapped around the lateral sides of bottom panel 22 to form peripheral sidewall 12. During one embodiment of this process, edge portions 24b of rear wall panel 20 (and end portions 62) are wrapped and positioned over lateral edges 48 and 50 of bottom panel 22. Tuck panels 52 are then folded upward against the outer side of rear wall panel at edge portions 24b as described above. The edge portions 24a (and end portions 60) of front wall panel 18 are then wrapped and positioned over lateral edges 48 and 50 of bottom panel 22 against the outer sides of tuck panels 52 and rear wall panel 20 (as shown in FIGS. 1 and 5) to form the fully enclosed sidewall 12 of scoop 10. During formation (or prior to) the bonding or adhesive agent used to seal the front and rear wall panels 18 and 20 together at overlapping seams 26 can be applied to edge portions 24b of rear wall panel 20 and/or edge portions 24a of front wall panel 18 along the height of overlapping seams 26 above the upwardly folded tuck panels 52 (which are positioned between front and rear wall panels 18 and 20 at the overlapping seams 26). The bonding or adhesive agent may also be applied to the edge portions 24a of the front wall portion in the region of the tuck panels 52. However, no bonding or adhesive agent needs to be applied to the edge portions 24b of rear wall panel 20 in the region of the tuck panels 52 because the forces from the secured overlapping seams 26 above the tuck panels 52 is sufficient to maintain the sealed shape and configuration of the tuck panels 52 and lower portion 14 of scoop 10. In this configuration, the tuck panels 52 are bonded to only one of the edge portions 24a of the front and rear wall panels 18 and 20 and remain un-bonded to the other in order to reduce the amount of adhesive or bonding agent necessary for the formation of the scoop 10. In other embodiments, the edge portions 24a of front wall panel 18 may be located to the interior of the scoop 10, the edge portions 24b of rear wall panel 20 may be located to the exterior of the scoop 10, and the tuck panels 52 may be located therebetween as described above.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A food scoop comprising:
a bottom panel;
a peripheral sidewall above said bottom panel, said peripheral sidewall forming an open upper end and comprising:
a front wall panel connected to a first longitudinal side edge of said bottom panel, said front wall panel including at least one side edge portion; and
a rear wall panel connected to a second longitudinal side edge of said bottom panel, said rear wall panel including at least one side edge portion arranged in an overlapping arrangement with said at least one side edge portion of said front wall panel to form an overlapping side seam; and
a side sealing flap folded upward from said bottom panel at said overlapping side seam;
wherein said side sealing flap is positioned between said at least one side edge portion of said front wall panel and said at least one side edge portion of said rear wall panel.

2. The food scoop of claim 1, further comprising an adhesive applied to at least one of said at least one side edge portions of said front and said rear wall panels above said side sealing flap within said overlapping side seam.

3. The food scoop of claim 2, wherein no adhesive is applied to said side sealing flap within said overlapping side seam.

4. The food scoop of claim 2, wherein said adhesive is further applied between said rear wall panel and an interior side of said side sealing flap within said overlapping side seam.

5. The food scoop of claim 1, wherein said side sealing flap is rectangular in shape.

6. The food scoop of claim 1, wherein said side sealing flap is trapezoidal in shape with a terminal free edge having a length less than a length of a base edge connecting said side sealing flap to said bottom panel.

7. The food scoop of claim 1, wherein said first and second longitudinal side edges of said bottom panel have a curved shape extending inward with respect to said front and rear wall panels.

8. The food scoop of claim 1, wherein said front wall panel includes a top edge having a curved and concave shape and said rear wall panel includes a top edge having a curved and convex shape.

9. A food scoop comprising:
a bottom panel comprising a pair of opposing longitudinal side edges and a pair of opposing lateral side edges;
a peripheral sidewall extending upward from said bottom panel, said peripheral sidewall comprising first and second wall panels connected to said opposing longitudinal side edges of said bottom panel, wherein said first and second wall panels include side edge portions extending beyond opposing longitudinal side edges of said bottom panel, wherein said side edge portions of said first wall panel are positioned in an overlapping arrangement with said side edge portions of said second wall panel to form a side seam on each side of said peripheral sidewall above said opposing lateral side edges of said bottom panel; and
first and second side sealing flaps connected to said opposing lateral side edges of said bottom panel and extending upward within said peripheral sidewall, wherein said first and second side sealing flaps are positioned between said first wall panel and said second wall panel at said side seams of said peripheral sidewall.

10. The food scoop of claim 9, wherein said first wall panel is located on an exterior of said peripheral sidewall along said side seam and said second wall panel is located on an interior of said peripheral sidewall along said side seam with each of said side sealing flaps being positioned therebetween.

11. The food scoop of claim 10, wherein a length of said side edge portions of said second wall panel is greater than or equal to a length of said lateral side edges of said bottom panel connected to said side sealing flaps.

12. The food scoop of claim 11, wherein a length of said side edge portions of said first wall panel is less than said length of said lateral side edges of said bottom panel connected to said side sealing flaps.

13. The food scoop of claim 10, wherein each said side sealing flap includes a base edge foldably connected to said lateral side edge of said bottom panel and a terminal free edge located opposite said base edge, wherein a length of said terminal free edge is less than a length of said base edge to provide said side sealing flaps with a trapezoidal shape.

14. The food scoop of claim 13, wherein said length of said terminal free edges of said side sealing flaps are entirely concealed by said side edge portions of said second wall panel on an interior side of said peripheral sidewall.

15. The food scoop of claim 14, wherein said base edges of said side sealing flaps are exposed on said interior side of said peripheral sidewall.

16. The food scoop of claim 9, further comprising an adhesive connecting said first and second wall panels together above said side sealing flaps along said side seams of said peripheral sidewall.

17. A blank for forming a one piece scoop have a sealed lower end, said blank comprising:
a bottom panel having front and rear longitudinal edges and opposing lateral edges;
a front wall panel foldably connected to said bottom panel along said front longitudinal edge, said front wall panel having a side edge portion extending away from said bottom panel;
a rear wall panel foldably connected to said bottom panel along said rear longitudinal edge, said rear wall panel having a side edge portion extending away from said bottom panel; and
a side sealing flap foldably connected to said bottom panel along one of said opposing lateral edges, said side sealing flap having a base edge connected to said bottom panel and a terminal free edge opposite said base edge;
wherein a length of said side edge portion of said rear wall panel is less than a length of said base edge of said side sealing flap.

18. The blank of claim 17, wherein a length of said terminal free edge of said side sealing flap is less than said length of said base edge of said side sealing flap, and wherein said length of said side edge portion of said rear wall panel is equal to or greater than said length of said terminal free edge plus half the difference between said length of said base edge and said length of said terminal free edge.

19. The blank of claim 18, wherein a length of said side edge portion of said front wall panel is less than said length of said base edge of said side sealing flap.

20. The blank of claim 19, wherein a length of said side edge portion of said front wall panel is less than said length of said side edge portion of said rear wall panel
